(19) United States
(12) Patent Application Publication
(10) Pub. No.: US 2024/0000080 A1
(43) Pub. Date: Jan. 4, 2024

(54) STABILIZED COMPOSITIONS CONTAINING STROBILURIN FUNGICIDES AND POLYHYDRIC ALCOHOLS

(71) Applicant: ADAMA MAKHTESHIM LTD., Beer Sheva (IL)

(72) Inventors: Jenny LERNER YARDENI, Mishmar Hanegev (IL); Eliyahu SHMOELI, Beer-Sheva (IL)

(21) Appl. No.: 18/254,936

(22) PCT Filed: Nov. 30, 2021
(86) PCT No.: PCT/IL2021/051421

§ 371 Date: May 30, 2023

Related U.S. Application Data
(60) Provisional application No. 63/119,689, filed on Dec. 1, 2020.

(51) Int. Cl. A01N 43/54; A01N 43/653; A01N 25/04; A01N 25/30

(52) U.S. Cl. CPC A01N 43/54; A01N 43/653; A01N 25/04; A01N 25/30

(57) ABSTRACT

The invention relates to compositions comprising at least one strobilurin fungicide, polar aprotic solvent, non-ionic emulsifier selected from a group comprising polyoxyethylated aromatics, polyalkoxylated alkyl ethers and any combination thereof, optionally one or more additional fungicides selected from the group comprising triazoles in the presence of at least one polyhydric alcohol compound. The compositions of the invention are novel and have high storage stability at high and low temperatures. The invention also relates to method of controlling phytopathogenic harmful fungi in crop protection and to the use thereof as crop protection agents.

### TECHNICAL FIELD OF THE INVENTION

The present invention relates to novel compositions of strobilurin fungicides which are highly stable, for controlling plant diseases and a method for controlling plant diseases.

### BACKGROUND OF THE INVENTION

Strobilurin fungicides have become a very valuable tool for managing diseases and are widely used in agriculture against several different plant pathogenic fungi. They belong to the QoI family of fungicides which are chemical compounds that act at the Quinol outer binding site of the cytochrome bc1 complex, inhibiting fungal mitochondrial respiration that stops energy production in the fungus and results in its death. The strobilurins like fluoxastrobin, mandestrobin, azoxystrobin, bifujunzhi, coumoxystrobin, enoxastrobin, flufenoxystrobin, jiaxiangjunzhi, picoxystrobin, pyraoxystrobin, pyraclostrobin, pyrametostrobin, triclopyricarb, dimoxystrobin, fenaminstrobin, metominostrobin, orysastrobin, kresoxim-methyl, trifloxystrobin, famoxadone and fenamidone are used on a wide variety of crops including cereals, field crops, fruits, tree nuts, vegetables, turfgrass and ornamentals.

Strobilurins are nonpolar compounds, they have relatively low water solubility and vary in their stability towards hydrolysis and photolysis under natural environmental conditions where pH and temperature contribute to their chemical degradation.

The efficacy of agrochemicals as crop protection agents is generally a function of the intrinsic properties of the active ingredients, such as their toxicity, plant movement, penetration capacity, and mechanism of action. However, it is also influenced by the formulation and the mode of application of the commercial product which includes solvents and/or solvent mixtures, emulsifiers and adjuvants among other parameters. Different formulations of the same active ingredient may have different efficacies. This is a result of formulation aids which can alter biological activity of the pesticide by, for example, changing the stability, solubility, crystallization, photochemical degradation, duration of delivery of the active ingredient etc.

There is a need to provide stable and novel compositions of strobilurins optionally with one or more additional fungicides for controlling plant diseases and a method for controlling plant diseases.

### SUMMARY

The present invention therefore provides compositions comprising at least one strobilurin fungicide, polar aprotic solvent, non-ionic emulsifier selected from a group comprising polyoxyethylated aromatics, polyalkoxylated alkyl ethers and any combination thereof, optionally one or more additional fungicides selected from the group comprising triazoles in the presence of at least one polyhydric alcohol compound. The invention further relates to compositions comprising about 1% to about 30% by weight of azoxystrobin based on the total weight of the composition, about 40% to about 70% by weight of benzyl acetate based on the total weight of the composition, about 1% to about 20% by weight of non-ionic emulsifier selected from a group comprising polyoxyethylated aromatics, polyalkoxylated alkyl ethers and any combination thereof based on the total weight of the composition, about 1% to about 30% by weight of prothioconazole based on the total weight of the composition, about 0.5% to about 0.6% by weight of propylene glycol based on the total weight of the composition.

The invention also relates to compositions comprising about 3% to about 20% by weight of azoxystrobin based on the total weight of the composition, about 45% to about 68% by weight of benzyl acetate based on the total weight of the composition, about 8% to about 15% by weight of non-ionic emulsifier selected from a group comprising polyoxyethylated aromatics, polyalkoxylated alkyl ethers and any combination thereof based on the total weight of the composition, about 5% to about 25% by weight of prothioconazole based on the total weight of the composition, about 0.6% to about 5% by weight of propylene glycol based on the total weight of the composition.

The invention further refers to a composition comprising about 11% by weight of azoxystrobin based on the total weight of the composition, about 66% by weight of benzyl acetate based on the total weight of the composition, about 11% by weight of non-ionic emulsifier selected from a group comprising polyoxyethylated aromatics, polyalkoxylated alkyl ethers and any combination thereof based on the total weight of the composition, about 8% by weight of prothioconazole based on the total weight of the composition, about 1.3% by weight of propylene glycol based on the total weight of the composition. The invention further relates to novel compositions for controlling plant diseases and a method for controlling plant diseases and the use thereof as crop protection agents.

### BRIEF DESCRIPTION OF THE DRAWINGS

FIG. 1. Formulations F1-F15 after 1 week at 54° C.

### DETAILED DESCRIPTION OF THE PREFERRED EMBODIMENTS

### Definitions

Prior to setting forth the present subject matter in detail, it may be helpful to provide definitions of certain terms to be used herein. Unless defined otherwise, all technical and scientific terms used herein have the same meaning as is commonly understood by one of skill in the art to which this subject matter pertains. The following definitions are provided for clarity.

The term “a” or “an” as used herein includes the singular and the plural, unless specifically stated otherwise. Therefore, the terms “a,” “an,” or “at least one” can be used interchangeably in this application. As used herein, the verb “comprise” as is used in this description and in the claims and its conjugations are used in its non-limiting sense to mean that items following the word are included, but items not specifically mentioned are not excluded.

As used herein, the term “about” when used in connection with a numerical value includes ±10% from the indicated value. In addition, all ranges directed to the same component or property herein are inclusive of the endpoints, are independently combinable, and include all intermediate points and ranges. It is understood that where a parameter range is provided, all integers within that range, and tenths thereof, are also provided by the invention.

As used herein, the term “effective amount” refers to an amount of the active component that is commercially recommended for use to control and/or prevent pest. The commercially recommended amount for each active component, often specified as application rates of the commercial formulation, may be found on the label accompanying the commercial formulation. The commercially recommended application rates of the commercial formulation may vary depending on factors such as the plant species and the pest to be controlled.

As used herein, the term “pest” includes, but is not limited to, unwanted phytopathogenic harmful fungi, unwanted insect, unwanted nematode, and weed.

As used herein, the term “pesticide” broadly refers to an agent that can be used to prevent, control and/or kill a pest. The term is understood to include but is not limited to fungicides, insecticides, nematicides, herbicides, acaricides, parasiticides or other control agents. For chemical classes and applications, as well as specific compounds of each class, see “The Pesticide Manual Thirteenth Edition” (British Crop Protection Council, Hampshire, UK, 2003), as well as “The e-Pesticide Manual, Version 3” (British Crop Protection Council, Hampshire, UK, 2003-04), the contents of each of which are incorporated herein by reference in their entirety.

As used herein, the term “locus” includes not only areas where the pest may already be developed, but also areas where pests have yet to emerge, and also to areas under cultivation. Locus includes the plant or crop and propagation material of the plant or crop. Locus also includes the area surrounding the plant or crop and the growing media of the plant or crop, such as soil and crop field.

As used herein the term “plant” or “crop” includes reference to whole plants, plant organs (e.g. leaves, stems, twigs, roots, trunks, limbs, shoots, fruits etc.), plant cells, or plant seeds. This term also encompasses plant crops such as fruits. spores, corms, bulbs, rhizomes, sprouts basal shoots, stolons, and buds and other parts of plants, including seedlings and young plants, which are to be transplanted after germination or after emergence from soil.

As used herein the term “ha” refers to hectare.

As used herein the term polyhydric alcohol compounds are organic molecules that have more than one hydroxyl group in them.

As used herein the term polyoxyethylated aromatic emulsifiers are commonly obtained by polycondensation of ethylene oxide with an aromatic compound optionally substituted.

The tristyrylphenol ethoxylate may be prepared by treating tristyrylphenol with a base (e.g. sodium hydroxide or potassium hydroxide) followed by addition of the desired equivalents of ethylene oxide. Tristyrylphenol is either commercially available, may be prepared by known procedures or otherwise may be prepared using conventional chemistry knowledge. Also, mixtures if different phenols (e.g. mixtures of tristyrylphenol and distyrylphenol) may be used as starting materials for preparing the phosphate ester surfactant components of the instant invention.

As used herein the term polyalkoxylated alkyl refers to compounds composed of a hydrophobic alkyl chain which is combined with a number of ethoxylate, or ethylene oxide, units via an ether linkage. They can also contain both ethylene oxide (EO) and propylene oxide (PO) in their hydrophilic moiety. The alkyl chain can contain up to 10 carbon atoms. An example for polyalkoxylated alkyl compound is poly(ethylene glycol-co-propylene glycol) monobutyl ether also known as ATLAS G-5002L.

It has surprisingly been found that a composition comprising strobilurins, polar aprotic solvent and non-ionic emulsifier selected from a group comprising polyoxyethylated aromatics, polyalkoxylated alkyl ethers and any combination thereof can be stabilized by the presence of at least one polyhydric alcohol compound such as ethylene glycol and propylene glycol. The compositions of the invention are novel and have high storage stability at high and low temperatures.

The present invention provides a composition comprising at least one strobilurin fungicide, polar aprotic solvent, non-ionic emulsifier selected from a group comprising polyoxyethylated aromatics, polyalkoxylated alkyl ethers and any combination thereof and optionally one or more additional fungicides selected from the group comprising triazoles, in the presence of at least one polyhydric alcohol compound.

In some embodiments, the at least one polyhydric alcohol compound is selected from a group comprising ethylene glycol, propylene glycol, glycerol, propylene glycol methyl ether and any combination thereof. In some embodiments, the at least one polyhydric alcohol compound is selected from a group comprising propylene glycol, glycerol, ethylene glycol and any combination thereof.

In some embodiments, composition comprising at least one strobilurin fungicide, polar aprotic solvent, non-ionic emulsifier selected from a group comprising polyoxyethylated aromatics, polyalkoxylated alkyl ethers and any combination thereof and optionally one or more additional fungicides selected from the group comprising triazoles, in the presence of propylene glycol.

In some embodiments, the amount of the at least one polyhydric alcohol compound is of about 0.5% to about 6% by weight, based on the total weight of the composition. In some embodiments, the amount of the at least one polyhydric alcohol compound is of about 0.6% to about 5% by weight, based on the total weight of the composition. In some embodiments, the amount of the at least one polyhydric alcohol compound is of about 0.7% to about 4% by weight, based on the total weight of the composition. In some embodiments, the amount of the at least one polyhydric alcohol compound is of about 0.7% to about 3% by weight, based on the total weight of the composition. In one embodiment, the amount of the at least one polyhydric alcohol compound is of about 1.4% by weight, based on the total weight of the composition.

In some embodiments, the amount of propylene glycol is of about 0.5% to about 6% by weight, based on the total weight of the composition. In some embodiments, the amount of propylene glycol is of about 0.6% to about 5% by weight, based on the total weight of the composition. In some embodiments, the amount of propylene glycol is of about 0.7% to about 4% by weight, based on the total weight of the composition. In some embodiments, the amount of propylene glycol is of about 0.7% to about 3% by weight, based on the total weight of the composition. In one embodiment, the amount of propylene glycol is of about 1.4% by weight, based on the total weight of the composition.

In some embodiments, the polar aprotic solvent is selected from a group comprising acetophenone, benzyl acetate, 2-heptanone, DMSO, Triisobutyl phosphate and any combination thereof.

In one embodiment, the polar aprotic solvent is benzyl acetate.

In one embodiment, the polar aprotic solvent is acetophenone.

In some embodiments, the amount of the polar aprotic solvent is of about 40% to about 70% by weight, based on the total weight of the composition. In some embodiments, the amount of the polar aprotic solvent is of about 45% to about 68% by weight, based on the total weight of the composition. In some embodiments, the amount of the polar aprotic solvent is of about 50% to about 66% by weight, based on the total weight of the composition.

In some embodiments, the amount of benzyl acetate is of about 40% to about 70% by weight, based on the total weight of the composition. In some embodiments, the amount of benzyl acetate is of about 45% to about 68% by weight, based on the total weight of the composition. In some embodiments, the amount of benzyl acetate is of about 50% to about 66% by weight, based on the total weight of the composition. In some embodiments, the amount of acetophenone is of about 40% to about 70% by weight, based on the total weight of the composition. In some embodiments, the amount of acetophenone is of about 45% to about 68% by weight, based on the total weight of the composition. In some embodiments, the amount of acetophenone is of about 50% to about 66% by weight, based on the total weight of the composition. In some embodiments, the composition comprising at least one strobilurin fungicide, benzyl acetate, non-ionic emulsifier selected from a group comprising polyoxyethylated aromatics, polyalkoxylated alkyl ethers and any combination thereof and optionally one or more additional fungicides selected from the group comprising triazoles, in the presence of at least one polyhydric alcohol compound.

The amount of the at least one polyhydric alcohol compound is of about 0.5% to about 6%, or about 0.6% to about 5%, or about 0.7% to about 4%, or about 0.8% to about 3%, or about 1.4% by weight, based on the total weight of the composition.

In some embodiments, the at least one polyhydric alcohol compound is at the amount of about 5% to about 50% by weight based on the total amount of the non-ionic emulsifier selected from a group comprising polyoxyethylated aromatics, polyalkoxylated alkyl ethers and any combination thereof.

In some embodiments, the at least one polyhydric alcohol compound is at the amount of about 6% to about 40% by weight based on the total amount of the non-ionic emulsifier selected from a group comprising polyoxyethylated aromatics, polyalkoxylated alkyl ethers and any combination thereof.

In some embodiments, the at least one polyhydric alcohol compound is at the amount of about 7% to about 30% by weight based on the total amount of the non-ionic emulsifier selected from a group comprising polyoxyethylated aromatics, polyalkoxylated alkyl ethers and any combination thereof.

In some embodiments, the at least one polyhydric alcohol compound is at the amount of about 8% to about 15% by weight based on the total amount of the non-ionic emulsifier selected from a group comprising polyoxyethylated aromatics, polyalkoxylated alkyl ethers and any combination thereof.

In one embodiment, the at least one polyhydric alcohol compound is at the amount of about 11% by weight based on the total amount of the non-ionic emulsifier selected from a group comprising polyoxyethylated aromatics, polyalkoxylated alkyl ethers and any combination thereof.

In some embodiments, the composition comprising at least one strobilurin fungicide, benzyl acetate, non-ionic emulsifier selected from a group comprising polyoxyethylated aromatics, polyalkoxylated alkyl ethers and any combination thereof and optionally one or more additional fungicides selected from the group comprising triazoles, in the presence of at least one polyhydric alcohol compound, wherein the at least one polyhydric alcohol compound is at the amount of about 5% to about 50% by weight based on the total amount of the non-ionic emulsifier selected from a group comprising polyoxyethylated aromatics, polyalkoxylated alkyl ethers and any combination thereof.

In some embodiments, the at least one strobilurin fungicide is selected from a group consisting of fluoxastrobin, mandestrobin, pyribencarb, azoxystrobin, bifujunzhi, coumoxystrobin, enoxastrobin, flufenoxystrobin, jiaxiangjunzhi, picoxystrobin, pyraoxystrobin, pyraclostrobin, pyrametostrobin, triclopyricarb, dimoxystrobin, fenaminstrobin, metominostrobin, orysastrobin, kresoxim-methyl, trifloxystrobin and any combination thereof.

In one embodiment, the at least one strobilurin fungicide is azoxystrobin.

In some embodiments, the amount of the at least one strobilurin fungicide is of about 1% to about 30% by weight, based on the total weight of the composition. In some embodiments, the amount of the at least one strobilurin fungicide is of about 3% to about 20% by weight, based on the total weight of the composition. In some embodiments, the amount of the at least one strobilurin fungicide is of about 5% to about 15% by weight, based on the total weight of the composition. In one embodiment, the amount of the at least one strobilurin fungicide is of about 11% by weight, based on the total weight of the composition.

In some embodiments, the amount of azoxystrobin is of about 1% to about 30% by weight, based on the total weight of the composition. In some embodiments, the amount of azoxystrobin is of about 3% to about 20% by weight, based on the total weight of the composition. In some embodiments, the amount of azoxystrobin is of about 5% to about 15% by weight, based on the total weight of the composition. In one embodiment, the amount of azoxystrobin is of about 11% by weight, based on the total weight of the composition.

In some embodiments, the composition comprising at least one strobilurin fungicide, polar aprotic solvent, non-ionic emulsifier selected from a group comprising polyoxyethylated aromatics, polyalkoxylated alkyl ethers and any combination thereof and optionally one or more additional fungicides selected from the group comprising triazoles, in the presence of at least one polyhydric alcohol compound.

The amount of at least one strobilurin fungicide is of about 1% to about 30%, or about 3% to about 20%, or about 5% to about 15%, or about 11% by weight, based on the total weight of the composition; the amount of the polar a protic solvent is of about 40% to about 70%, or about 45% to about 68%, or about 50% to about 66%, by weight, based on the total weight of the composition; the amount of the at least one polyhydric alcohol compound is of about 0.5% to about 6%, or about 0.6% to about 5%, or about 0.7% to about 4%, or about 0.7% to about 3%, or about 1.4% by weight, based on the total weight of the composition.

In some embodiments, the composition comprising azoxystrobin, polar aprotic solvent, non-ionic emulsifier selected from a group comprising polyoxyethylated aromatics, polyalkoxylated alkyl ethers and any combination thereof and optionally one or more additional fungicides selected from the group comprising triazoles, in the presence of at least one polyhydric alcohol compound.

The amount azoxystrobin is of about 1% to about 30%, or about 3% to about 20%, or about 5% to about 15%, or about 11% by weight, based on the total weight of the composition; the amount of the polar a protic solvent is of about 40% to about 70%, or about 45% to about 68%, or about 50% to about 66%, by weight, based on the total weight of the composition; the amount of the at least one polyhydric alcohol compound is of about 0.5% to about 6%, or about 0.6% to about 5%, or about 0.7% to about 4%, or about 0.7% to about 3%, or about 1.4% by weight, based on the total weight of the composition.

In some embodiments, the composition comprising azoxystrobin, benzyl acetate, non-ionic emulsifier selected from a group comprising polyoxyethylated aromatics, polyalkoxylated alkyl ethers and any combination thereof and optionally one or more additional fungicides selected from the group comprising triazoles, in the presence of at least one polyhydric alcohol compound.

The amount azoxystrobin is of about 1% to about 30%, or about 3% to about 20%, or about 5% to about 15%, or about 11% by weight, based on the total weight of the composition; the amount of benzyl acetate is of about 40% to about 70%, or about 45% to about 68%, or about 55% to about 66%, or about 55% or about 65% by weight, based on the total weight of the composition; the amount of the at least one polyhydric alcohol compound is of about 0.5% to about 6%, or about 0.6% to about 5%, or about 0.7% to about 4%, or about 0.7% to about 3%, or about 1.4% by weight, based on the total weight of the composition.

In some embodiments, the composition comprising azoxystrobin, acetophenone, non-ionic emulsifier selected from a group comprising polyoxyethylated aromatics, polyalkoxylated alkyl ethers and any combination thereof and optionally one or more additional fungicides selected from the group comprising triazoles, in the presence of at least one polyhydric alcohol compound.

The amount azoxystrobin is of about 1% to about 30%, or about 3% to about 20%, or about 5% to about 15%, or about 11% by weight, based on the total weight of the composition; the amount of acetophenone is of about 40% to about 70%, or about 45% to about 68%, or about 55% to about 66%, or about 55% or about 65% by weight, based on the total weight of the composition; the amount of the at least one polyhydric alcohol compound is of about 0.5% to about 6%, or about 0.6% to about 5%, or about 0.7% to about 4%, or about 0.7% to about 3%, or about 1.4% by weight, based on the total weight of the composition.

In some embodiments, the amount of the non-ionic emulsifier selected from a group comprising polyoxyethylated aromatics, polyalkoxylated alkyl ethers and any combination thereof is of about 1% to about 20% by weight, based on the total weight of the composition. In some embodiments, the amount of the non-ionic emulsifier selected from a group comprising polyoxyethylated aromatics, polyalkoxylated alkyl ethers and any combination thereof is of about 8% to about 15% by weight, based on the total weight of the composition. In one embodiment, the amount of the non-ionic emulsifier selected from a group comprising polyoxyethylated aromatics, polyalkoxylated alkyl ethers and any combination thereof is of about 10% to by weight, based on the total weight of the composition. In different embodiment, the amount of the non-ionic emulsifier selected from a group comprising polyoxyethylated aromatics, polyalkoxylated alkyl ethers and any combination thereof is of about 11% to by weight, based on the total weight of the composition.

In some embodiments, the composition comprising at least one strobilurin fungicide, polar aprotic solvent, non-ionic emulsifier selected from a group comprising polyoxyethylated aromatics, polyalkoxylated alkyl ethers and any combination thereof and optionally one or more additional fungicides selected from the group comprising triazoles, in the presence of at least one polyhydric alcohol compound.

The amount of at least one strobilurin fungicide is of about 1% to about 30%, or about 3% to about 20%, or about 5% to about 15%, or about 11% by weight, based on the total weight of the composition; the amount of the polar a protic solvent is of about 40% to about 70%, or about 45% to about 68%, or about 50% to about 66%, by weight, based on the total weight of the composition; the amount of the non-ionic emulsifier selected from a group comprising polyoxyethylated aromatics, polyalkoxylated alkyl ethers and any combination thereof is of about 1% to about 20%, or about 8% to about 15%, or about 11%, or about 10% by weight, based on the total weight of the composition; the amount of the at least one polyhydric alcohol compound is of about 0.5% to about 6%, or about 0.6% to about 5%, or about 0.7% to about 4%, or about 0.7% to about 3%, or about 1.4% by weight, based on the total weight of the composition.

In some embodiments, the composition comprising azoxystrobin, polar aprotic solvent, non-ionic emulsifier selected from a group comprising polyoxyethylated aromatics, polyalkoxylated alkyl ethers and any combination thereof and optionally one or more additional fungicides selected from the group comprising triazoles, in the presence of at least one polyhydric alcohol compound.

The amount of azoxystrobin is of about 1% to about 30%, or about 3% to about 20%, or about 5% to about 15%, or about 11% by weight, based on the total weight of the composition; the amount of the polar a protic solvent is of about 40% to about 70%, or about 45% to about 68%, or about 50% to about 66%, by weight, based on the total weight of the composition; the amount of the non-ionic emulsifier selected from a group comprising polyoxyethylated aromatics, polyalkoxylated alkyl ethers and any combination thereof is of about 1% to about 20%, or about 8% to about 15%, or about 11%, or about 10% by weight, based on the total weight of the composition; the amount of the at least one polyhydric alcohol compound is of about 0.5% to about 6%, or about 0.6% to about 5%, or about 0.7% to about 4%, or about 0.7% to about 3%, or about 1.4% by weight, based on the total weight of the composition.

In some embodiments, the composition comprising azoxystrobin, benzyl acetate, non-ionic emulsifier selected from a group comprising polyoxyethylated aromatics, polyalkoxylated alkyl ethers and any combination thereof and optionally one or more additional fungicides selected from the group comprising triazoles, in the presence of at least one polyhydric alcohol compound.

The amount of azoxystrobin is of about 1% to about 30%, or about 3% to about 20%, or about 5% to about 15%, or about 11% by weight, based on the total weight of the composition; the amount of benzyl acetate is of about 40% to about 70%, or about 45% to about 68%, or about 50% to about 66%, by weight, based on the total weight of the composition; the amount of the non-ionic emulsifier selected from a group comprising polyoxyethylated aromatics, polyalkoxylated alkyl ethers and any combination thereof is of about 1% to about 20%, or about 8% to about 15%, or about 11%, or about 10% by weight, based on the total weight of the composition; the amount of the at least one polyhydric alcohol compound is of about 0.5% to about 6%, or about 0.6% to about 5%, or about 0.7% to about 4%, or about 0.7% to about 3%, or about 1.4% by weight, based on the total weight of the composition.

In some embodiments, the agrochemical composition comprising azoxystrobin, acetophenone, non-ionic emulsifier selected from a group comprising polyoxyethylated aromatics, polyalkoxylated alkyl ethers and any combination thereof and optionally one or more additional fungicides selected from the group comprising triazoles, in the presence of at least one polyhydric alcohol compound.

The amount of azoxystrobin is of about 1% to about 30%, or about 3% to about 20%, or about 5% to about 15%, or about 11% by weight, based on the total weight of the composition; the amount of acetophenone is of about 40% to about 70%, or about 45% to about 68%, or about 50% to about 66%, by weight, based on the total weight of the composition; the amount of the non-ionic emulsifier selected from a group comprising polyoxyethylated aromatics, polyalkoxylated alkyl ethers and any combination thereof is of about 1% to about 20%, or about 8% to about 15%, or about 11%, or about 10% by weight, based on the total weight of the composition; the amount of the at least one polyhydric alcohol compound is of about 0.5% to about 6%, or about 0.6% to about 5%, or about 0.7% to about 4%, or about 0.7% to about 3%, or about 1.4% by weight, based on the total weight of the composition.

In some embodiments, the amount of the non-ionic emulsifier selected from a group comprising of polyoxyethylated aromatics, polyalkoxylated alkyl ethers and any combination thereof is of about 1% to about 20% by weight, based on the total weight of the composition. In some embodiments, the amount of the non-ionic emulsifier selected from a group comprising of polyoxyethylated aromatics, polyalkoxylated alkyl ethers and any combination thereof is of about 8% to about 15% by weight, based on the total weight of the composition. In some embodiments, the amount of the non-ionic emulsifier selected from a group comprising of polyoxyethylated aromatics, polyalkoxylated alkyl ethers and any combination thereof is of about 10% by weight, based on the total weight of the composition. In some embodiments, the amount of the non-ionic emulsifier selected from a group comprising of polyoxyethylated aromatics, polyalkoxylated alkyl ethers and any combination thereof is of about 11% by weight, based on the total weight of the composition.

In some embodiments, the composition comprising at least one strobilurin fungicide, polar aprotic solvent, polyoxyethylated aromatic non-ionic emulsifier and optionally one or more additional fungicides selected from the group comprising triazoles, in the presence of at least one polyhydric alcohol compound.

The amount the at least one strobilurin fungicide is of about 1% to about 30%, or about 3% to about 20%, or about 5% to about 15%, or about 11% by weight, based on the total weight of the composition; the amount of polar aprotic solvent is of about 40% to about 70%, or about 45% to about 68%, or about 55% to about 66%, or about 55% or about 65% by weight, based on the total weight of the composition; the amount of the polyoxyethylated aromatic is of about 1% to about 20%, or about 8% to about 15%, or about 11%, or about 10% by weight, based on the total weight of the composition; the amount of the at least one polyhydric alcohol compound is of about 0.5% to about 6%, or about 0.6% to about 5%, or about 0.7% to about 4%, or about 0.7% to about 3%, or about 1.4% by weight, based on the total weight of the composition.

The amount of the at least one polyhydric alcohol compound is of about 5% to about 50%, or about 6% to about 40%, or about 7% to about 30%, or about 8% to about 15%, or about 12% by weight based on the total amount of the polyoxyethylated aromatic.

In some embodiments, the composition comprising azoxystrobin, polar aprotic solvent, polyoxyethylated aromatic and optionally one or more additional fungicides selected from the group comprising triazoles, in the presence of at least one polyhydric alcohol compound.

The amount azoxystrobin is of about 1% to about 30%, or about 3% to about 20%, or about 5% to about 15%, or about 11% by weight, based on the total weight of the composition; the amount of polar aprotic solvent is of about 40% to about 70%, or about 45% to about 68%, or about 55% to about 66%, or about 55% or about 65% by weight, based on the total weight of the composition; the amount of the polyoxyethylated aromatic is of about 1% to about 20%, or about 8% to about 15%, or about 11%, or about 10% by weight, based on the total weight of the composition; the amount of the at least one polyhydric alcohol compound is of about 0.5% to about 6%, or about 0.6% to about 5%, or about 0.7% to about 4%, or about 0.7% to about 3%, or about 1.4% by weight, based on the total weight of the composition.

The amount of the at least one polyhydric alcohol compound is of about 5% to about 50%, or about 6% to about 40%, or about 7% to about 30%, or about 8% to about 15%, or about 12% by weight based on the total amount of the polyoxyethylated aromatic.

In some embodiments, the composition comprising azoxystrobin, benzyl acetate, polyoxyethylated aromatic and optionally one or more additional fungicides selected from the group comprising triazoles, in the presence of at least one polyhydric alcohol compound.

The amount azoxystrobin is of about 1% to about 30%, or about 3% to about 20%, or about 5% to about 15%, or about 11% by weight, based on the total weight of the composition; the amount of benzyl acetate is of about 40% to about 70%, or about 45% to about 68%, or about 55% to about 66%, or about 55% or about 65% by weight, based on the total weight of the composition; the amount of the polyoxyethylated aromatic is of about 1% to about 20%, or about 8% to about 15%, or about 11%, or about 10% by weight, based on the total weight of the composition; the amount of the at least one polyhydric alcohol compound is of about 0.5% to about 6%, or about 0.6% to about 5%, or about 0.7% to about 4%, or about 0.7% to about 3%, or about 1.4% by weight, based on the total weight of the composition.

The amount of the at least one polyhydric alcohol compound is of about 5% to about 50%, or about 6% to about 40%, or about 7% to about 30%, or about 8% to about 15%, or about 12% by weight based on the total amount of the polyoxyethylated aromatic.

In some embodiments, the composition comprising azoxystrobin, acetophenone, polyoxyethylated aromatic and optionally one or more additional fungicides selected from the group comprising triazoles, in the presence of at least one polyhydric alcohol compound.

The amount azoxystrobin is of about 1% to about 30%, or about 3% to about 20%, or about 5% to about 15%, or about 11% by weight, based on the total weight of the composition; the amount of acetophenone is of about 40% to about 70%, or about 45% to about 68%, or about 55% to about 66%, or about 55% or about 65% by weight, based on the total weight of the composition; the amount of the polyoxyethylated aromatic is of about 1% to about 20%, or about 8% to about 15%, or about 11%, or about 10% by weight, based on the total weight of the composition; the amount of the at least one polyhydric alcohol compound is of about 0.5% to about 6%, or about 0.6% to about 5%, or about 0.7% to about 4%, or about 0.7% to about 3%, or about 1.4% by weight, based on the total weight of the composition.

The amount of the at least one polyhydric alcohol compound is of about 5% to about 50%, or about 6% to about 40%, or about 7% to about 30%, or about 8% to about 15%, or about 12% by weight based on the total amount of the polyoxyethylated aromatic.

In some embodiments, the polyoxyethylated aromatic is selected from the family of tristyrylphenol ethoxylates.

In some embodiments, the amount of tristyrylphenol ethoxylates is of about 1% to about 20% by weight, based on the total weight of the composition. In some embodiments, the amount of tristyrylphenol ethoxylates is of about 8% to about 15% by weight, based on the total weight of the composition. In one embodiment, the amount of tristyrylphenol ethoxylates is of about 10% by weight, based on the total weight of the composition. In other embodiment, the amount of tristyrylphenol ethoxylates is of about 11% by weight, based on the total weight of the composition.

In some embodiments, the amount of the at least one polyhydric alcohol compound is of about 5% to about 50%, or about 6% to about 40%, or about 7% to about 30%, or about 8% to about 15%, or about 12% by weight based on the total amount of the tristyrylphenol ethoxylate.

In some embodiments, the composition comprising at least one strobilurin fungicide, polar aprotic solvent, tristyrylphenol ethoxylate and optionally one or more additional fungicides selected from the group comprising triazoles, in the presence of at least one polyhydric alcohol compound.

The amount of the at least one strobilurin fungicide is of about 1% to about 30%, or about 3% to about 20%, or about 5% to about 15%, or about 11% by weight, based on the total weight of the composition; the amount of polar aprotic solvent is of about 40% to about 70%, or about 45% to about 68%, or about 55% to about 66%, or about 55% or about 65% by weight, based on the total weight of the composition; the amount of the tristyrylphenol ethoxylate is of about 1% to about 20%, or about 8% to about 15%, or about 11%, or about 10% by weight, based on the total weight of the composition; the amount of the at least one polyhydric alcohol compound is of about 0.5% to about 6%, or about 0.6% to about 5%, or about 0.7% to about 4%, or about 0.7% to about 3%, or about 1.4% by weight, based on the total weight of the composition.

The amount of the at least one polyhydric alcohol compound is of about 5% to about 50%, or about 6% to about 40%, or about 7% to about 30%, or about 8% to about 15%, or about 12% by weight based on the total amount of the tristyrylphenol ethoxylate.

In some embodiments, the composition comprising azoxystrobin, polar aprotic solvent, tristyrylphenol ethoxylate and optionally one or more additional fungicides selected from the group comprising triazoles, in the presence of at least one polyhydric alcohol compound.

The amount azoxystrobin is of about 1% to about 30%, or about 3% to about 20%, or about 5% to about 15%, or about 11% by weight, based on the total weight of the composition; the amount of polar aprotic solvent is of about 40% to about 70%, or about 45% to about 68%, or about 55% to about 66%, or about 55% or about 65% by weight, based on the total weight of the composition; the amount of the tristyrylphenol ethoxylate is of about 1% to about 20%, or about 8% to about 15%, or about 11%, or about 10% by weight, based on the total weight of the composition; the amount of the at least one polyhydric alcohol compound is of about 0.5% to about 6%, or about 0.6% to about 5%, or about 0.7% to about 4%, or about 0.7% to about 3%, or about 1.4% by weight, based on the total weight of the composition. The amount of the at least one polyhydric alcohol compound is of about 5% to about 50%, or about 6% to about 40%, or about 7% to about 30%, or about 8% to about 15%, or about 12% by weight based on the total amount of the tristyrylphenol ethoxylate.

In some embodiments, the composition comprising azoxystrobin, benzyl acetate, tristyrylphenol ethoxylate and optionally one or more additional fungicides selected from the group comprising triazoles, in the presence of at least one polyhydric alcohol compound.

The amount azoxystrobin is of about 1% to about 30%, or about 3% to about 20%, or about 5% to about 15%, or about 11% by weight, based on the total weight of the composition; the amount of benzyl acetate is of about 40% to about 70%, or about 45% to about 68%, or about 55% to about 66%, or about 55% or about 65% by weight, based on the total weight of the composition; the amount of the tristyrylphenol ethoxylate is of about 1% to about 20%, or about 8% to about 15%, or about 11%, or about 10% by weight, based on the total weight of the composition; the amount of the at least one polyhydric alcohol compound is of about 0.5% to about 6%, or about 0.6% to about 5%, or about 0.7% to about 4%, or about 0.7% to about 3%, or about 1.4% by weight, based on the total weight of the composition.

The amount of the at least one polyhydric alcohol compound is of about 5% to about 50%, or about 6% to about 40%, or about 7% to about 30%, or about 8% to about 15%, or about 12% by weight based on the total amount of the tristyrylphenol ethoxylate.

In some embodiments, the composition comprising azoxystrobin, acetophenone, tristyrylphenol ethoxylate and optionally one or more additional fungicides selected from the group comprising triazoles, in the presence of at least one polyhydric alcohol compound.

The amount azoxystrobin is of about 1% to about 30%, or about 3% to about 20%, or about 5% to about 15%, or about 11% by weight, based on the total weight of the composition; the amount of acetophenone is of about 40% to about 70%, or about 45% to about 68%, or about 55% to about 66%, or about 55% or about 65% by weight, based on the total weight of the composition; the amount of the tristyrylphenol ethoxylate is of about 1% to about 20%, or about 8% to about 15%, or about 11%, or about 10% by weight, based on the total weight of the composition; the amount of the at least one polyhydric alcohol compound is of about 0.5% to about 6%, or about 0.6% to about 5%, or about 0.7% to about 4%, or about 0.7% to about 3%, or about 1.4% by weight, based on the total weight of the composition.

The amount of the at least one polyhydric alcohol compound is of about 5% to about 50%, or about 6% to about 40%, or about 7% to about 30%, or about 8% to about 15%, or about 12% by weight based on the total amount of the tristyrylphenol ethoxylate.

In some embodiments, the functional properties of the non-ionic emulsifier can be modified by changing the chemical structure of the hydrophobic moiety and structure of the hydrophilic moiety linked to the hydrophilic moiety such as length or extent of ethoxylation, and hence the HLB. In some embodiments, the HLB of the non-ionic emulsifier is equal or above 12. In some embodiments, the length of the ethylene oxide moiety of the non-ionic emulsifier is equal or above 16. In some embodiments, the non-ionic emulsifiers have HLB equal or above 12 and the length of the ethylene oxide moiety is equal or above 16. In some embodiments the pH of 5% of the emulsifier in water is not above 9; In an additional embodiment, the pH of 5% of the emulsifier is water is of about 5-7.

In some embodiments, the preferred tristyrylphenol ethoxylates emulsifiers are for example SOPROPHOR™ emulsifiers available from Rhodia. Examples of Soprophors available commercially include SOPROPHOR 796/P, SOPROPHOR CY/8, SOPROPHOR TS/16, SOPROPHOR S/40-FLAKE, SOPROPHOR TS/54, SOPROPHOR S25/80, SOPROPHOR BSU, SOPROPHOR TS10, and SOPROPHOR TS29. Especially preferred are SOPROPHOR CY/8, and SOPROPHOR TS/16.

Other Soprophors have similar structures to the structure shown above, except that the length of the ethylene oxide chain varies from about 3 to about 50 ethylene oxide repeating units.

In some embodiments, the one or more additional fungicides selected from the group comprising triazoles is selected from a group consisting of azaconazole, bromuconazole, cyproconazole, diclobutrazol, difenoconazole, diniconazole, diniconazole-M, epoxiconazole, etaconazole, fenbuconazole, fluoxytioconazole, fluquinconazole, flusilazole, flutriafol, furconazole, furconazole-cis, hexaconazole, imibenconazole, ipconazole, ipfentrifluconazole, mefentrifluconazole, metconazole, myclobutanil, penconazole, propiconazole, prothioconazole, quinconazole, simeconazole, tebuconazole, tetraconazole, triadimefon, triadimenol, triticonazole, uniconazole, uniconazole-P and any combination thereof.

In one embodiment, the one or more additional fungicides selected from the group comprising triazoles is prothioconazole.

In some embodiments, the amount of the one or more additional fungicide selected from the group comprising triazoles is of about 1% to about 30% by weight, based on the total weight of the composition.

In some embodiments, the amount of the one or more additional fungicide selected from the group comprising triazoles is of about 5% to about 25% by weight, based on the total weight of the composition.

In some embodiments, the amount of the one or more additional fungicide selected from the group comprising triazoles is of about 8% by weight, based on the total weight of the composition. In some embodiments, the amount of the one or more additional fungicide selected from the group comprising triazoles is of about 20% by weight, based on the total weight of the composition.

In some embodiments, the amount of prothioconazole is of about 1% to about 30% by weight, based on the total weight of the composition. In some embodiments, the amount of prothioconazole is of about 5% to about 25% by weight, based on the total weight of the composition. In some embodiments, the amount of prothioconazole is of about 20% by weight, based on the total weight of the composition. In one embodiment, the amount of prothioconazole is of about 8% by weight, based on the total weight of the composition.

In some embodiments, the ratio between the polar aprotic solvent and the at least one polyhydric alcohol compound is of about 8:1 to about 350:1. In some embodiments, the ratio between the polar aprotic solvent and the at least one polyhydric alcohol compound is of about 20:1 to about 120:1. In some embodiments, the ratio between the polar aprotic solvent and the at least one polyhydric alcohol compound is of about 110:1. In some embodiments, the ratio between the polar aprotic solvent and the at least one polyhydric alcohol compound is of about 100:1. In some embodiments, the ratio between the polar aprotic solvent and the at least one polyhydric alcohol compound is of about 51:1.

In some embodiments, the ratio between the polar aprotic solvent and propylene glycol is of about 8:1 to about 350:1. In some embodiments, the ratio between the polar aprotic solvent and propylene glycol is of about 20:1 to about 120:1. In some embodiments, the ratio between the polar aprotic solvent and propylene glycol is of about 51:1. In some embodiments, the ratio between the polar aprotic solvent and propylene glycol is of about 110:1. In some embodiments, the ratio between the polar aprotic solvent and propylene glycol is of about 100:1.

In some embodiments, the ratio between benzyl acetate and propylene glycol is of about 8:1 to about 350:1. In some embodiments, the ratio between benzyl acetate and propylene glycol is of about 20:1 to about 120:1. In some embodiments, the ratio between benzyl acetate and propylene glycol is of about 110:1. In some embodiments, the ratio between benzyl acetate and propylene glycol is of about 100:1. In some embodiments, the ratio between benzyl acetate and propylene glycol is of about 51:1.

In some embodiments, the ratio between acetophenone and propylene glycol is of about 8:1 to about 350:1.

In some embodiments, the ratio between acetophenone and propylene glycol is of about 20:1 to about 120:1. In some embodiments, the ratio between acetophenone and propylene glycol is of about 110:1. In some embodiments, the ratio between acetophenone and propylene glycol is of about 100:1. In some embodiments, the ratio between acetophenone and propylene glycol is of about 51:1.

In one embodiment, the composition comprising azoxystrobin, benzyl acetate, polyoxyethylated aromatic, prothioconazole, in the presence of at least one polyhydric alcohol compound.

The amount of azoxystrobin is of about 1% to about 30%, or about 3% to about 20%, or about 5% to about 15%, or about 11% by weight, based on the total weight of the composition; the amount of benzyl acetate is of about 40% to about 70%, or about 45% to about 68%, or about 55% to about 66%, or about 55%, or about 65% by weight, based on the total weight of the composition; the amount of the polyoxyethylated aromatic is about 1% to about 20%, or about 8% to about 15%, or about 11%, or about 10% by weight, based on the total weight of the composition; the amount of prothioconazole is of about 1% to about 30%, or about 5% to about 25%, or about 20%, or about 8% by weight, based on the total weight of the composition; the amount of the at least one polyhydric alcohol compound is of about 0.5% to about 6%, or about 0.6% to about 5%, or about 0.7% to about 4%, or about 0.7% to about 3%, or about 1.4% by weight, based on the total weight of the composition.

The amount of the at least one polyhydric alcohol compound is of about 5% to about 50%, or about 6% to about 40%, or about 7% to about 30%, or about 8% to about 15%, or about 12% by weight based on the total amount of the polyoxyethylated aromatic.

In one embodiment, the composition comprising azoxystrobin, benzyl acetate, tristyrylphenol ethoxylate, prothioconazole, in the presence of at least one polyhydric alcohol compound.

The amount of azoxystrobin is of about 1% to about 30%, or about 3% to about 20%, or about 5% to about 15%, or about 11% by weight, based on the total weight of the composition; the amount of benzyl acetate is of about 40% to about 70%, or about 45% to about 68%, or about 55% to about 66%, or about 55% or about 65% by weight, based on the total weight of the composition; the amount of the tristyrylphenol ethoxylate is about 1% to about 20%, or about 8% to about 15%, or about 11%, or about 10% by weight, based on the total weight of the composition; the amount of prothioconazole is of about 1% to about 30%, or about 5% to about 25%, or about 20%, or about 8% by weight, based on the total weight of the composition; the amount of the at least one polyhydric alcohol compound is of about 0.6% to about 6%, or about 0.6% to about 5%, or about 0.7% to about 4%, or about 0.7% to about 3%, or about 1.4% by weight, based on the total weight of the composition.

The amount of the at least one polyhydric alcohol compound is of about 5% to about 50%, or about 6% to about 40%, or about 7% to about 30%, or about 8% to about 15%, or about 12% by weight based on the total amount of the tristyrylphenol ethoxylate.

In one embodiment, the composition comprising azoxystrobin, benzyl acetate, tristyrylphenol ethoxylate, prothioconazole, in the presence of propylene glycol.

The amount of azoxystrobin is of about 1% to about 30%, or about 3% to about 20%, or about 5% to about 15%, or about 11% by weight, based on the total weight of the composition; the amount of benzyl acetate is of about 40% to about 70%, or about 45% to about 68%, or about 55% to about 66%, or about 55%, or about 65% by weight, based on the total weight of the composition; the amount of the tristyrylphenol ethoxylate is about 1% to about 20%, or about 8% to about 15%, or about 11%, or about 10% by weight, based on the total weight of the composition; the amount of prothioconazole is of about 1% to about 30%, or about 5% to about 25%, or about 20%, or about 8% by weight, based on the total weight of the composition; the amount of propylene glycol is of about 0.5% to about 6%, or about 0.6% to about 5%, or about 0.7% to about 4%, or about 0.7% to about 3%, or about 1.4% by weight, based on the total weight of the composition.

The amount of propylene glycol is of about 5% to about 50%, or about 6% to about 40%, or about 7% to about 30%, or about 8% to about 15%, or about 12% by weight based on the total amount of the tristyrylphenol ethoxylate.

In one embodiment, the composition comprising azoxystrobin, benzyl acetate, tristyrylphenol ethoxylate, prothioconazole, in the presence of propylene glycol wherein the amount of propylene glycol is of about 5% to about 50%, or about 6% to about 40%, or about 7% to about 30%, or about 8% to about 15%, or about 12% by weight based on the total amount of the tristyrylphenol ethoxylate.

The amount of azoxystrobin is of about 1% to about 30%, or about 3% to about 20%, or about 5% to about 15%, or about 11% by weight, based on the total weight of the composition; the amount of benzyl acetate is of about 40% to about 70%, or about 45% to about 68%, or about 55% to about 66%, or about 55% or about 65% by weight, based on the total weight of the composition; the amount of the tristyrylphenol ethoxylate is about 1% to about 20%, or about 8% to about 15%, or about 11%, or about 10% by weight, based on the total weight of the composition; the amount of prothioconazole is of about 1% to about 30%, or about 5% to about 25%, or about 20%, or about 8% by weight, based on the total weight of the composition; the amount of propylene glycol is of about 0.5% to about 6%, or about 0.6% to about 5%, or about 0.7% to about 4%, or about 0.7% to about 3%, or about 1.4% by weight, based on the total weight of the composition.

In one embodiment, the composition comprising azoxystrobin, benzyl acetate, tristyrylphenol ethoxylate, prothioconazole, in the presence of propylene glycol wherein the amount of propylene glycol is of about 8% to about 15%, by weight based on the total amount of the tristyrylphenol ethoxylate.

The amount of azoxystrobin is of about 5% to about 15%, by weight, based on the total weight of the composition; the amount of benzyl acetate is of about 55% to about 66% by weight, based on the total weight of the composition; the amount of the tristyrylphenol ethoxylate is about 8% to about 15% by weight, based on the total weight of the composition; the amount of prothioconazole is of about 5% to about 15% by weight, based on the total weight of the composition; the amount of propylene glycol is of about 0.7% to about 3% by weight, based on the total weight of the composition.

In one embodiment, the composition comprising azoxystrobin, benzyl acetate, tristyrylphenol ethoxylate, prothioconazole, in the presence of propylene glycol wherein the amount of propylene glycol is of about 12% by weight based on the total amount of the tristyrylphenol ethoxylate.

The amount of azoxystrobin is of about 11% by weight, based on the total weight of the composition; the amount of benzyl acetate is of about 55% to about 66% by weight, based on the total weight of the composition; the amount of the tristyrylphenol ethoxylate is about 8% to about 15% by weight, based on the total weight of the composition; the amount of prothioconazole is of about 8% by weight, based on the total weight of the composition; the amount of propylene glycol is of about 0.5% to about 6%, or about 0.6% to about 5%, or about 0.7% to about 4%, or about 0.7% to about 3%, or about 1.4% by weight, based on the total weight of the composition.

In some embodiments, the composition comprising azoxystrobin, benzyl acetate, non-ionic emulsifier selected from a group comprising polyoxyethylated aromatics, polyalkoxylated alkyl ethers and any combination thereof, prothioconazole, in the presence of propylene glycol.

In one embodiment, the amount of propylene glycol is of about 1.3% by weight, based on the total weight of the composition.

In one embodiment, the composition comprising about 11% by weight of azoxystrobin based on the total weight of the composition, about 66% by weight of benzyl acetate based on the total weight of the composition, about 11% by weight of non-ionic emulsifier selected from a group comprising polyoxyethylated aromatics, polyalkoxylated alkyl ethers and any combination thereof based on the total weight of the composition, about 8% by weight of prothioconazole based on the total weight of the composition, about 1.3% by weight of propylene glycol based on the total weight of the composition.

In some embodiments, the polyoxyethylated aromatic is selected from the family of tristyrylphenol ethoxylates.

In some embodiments, the polyalkoxylated alkyl ether is selected from the family of polyalkoxylated butyl ethers.

In some embodiment, the composition comprising azoxystrobin, benzyl acetate, non-ionic emulsifier selected from tristyrylphenol ethoxylates, polyalkoxylated butyl ethers and any combination thereof, prothioconazole, in the presence of propylene glycol.

In one embodiment, the amount of propylene glycol is of about 1.3% by weight, based on the total weight of the composition.

In one embodiment, the composition comprising about 11% by weight of azoxystrobin based on the total weight of the composition, about 66% by weight of benzyl acetate based on the total weight of the composition, about 11% by weight of non-ionic emulsifier selected from a group comprising tristyrylphenol ethoxylates, polyalkoxylated butyl ethers and any combination thereof based on the total weight of the composition, about 8% by weight of prothioconazole based on the total weight of the composition about 1.3% by weight of propylene glycol based on the total weight of the composition.

In some embodiments, the composition comprising at least one strobilurin fungicide, polar aprotic solvent, non-ionic emulsifier selected from a group comprising tristyrylphenol ethoxylates, polyalkoxylated butyl ethers and any combination thereof, optionally one or more additional fungicides selected from the group comprising triazoles, in the presence of at least one polyhydric alcohol compound.

In some embodiments, the composition comprising at least one strobilurin fungicide, polar aprotic solvent, non-ionic emulsifier selected from a group comprising tristyrylphenol ethoxylates, polyalkoxylated butyl ethers and any combination thereof, optionally one or more additional fungicides selected from the group comprising triazoles, in the presence of propylene glycol.

In some embodiments, the composition comprising at least one strobilurin fungicide, polar aprotic solvent, non-ionic emulsifier selected from a group comprising tristyrylphenol ethoxylates, polyalkoxylated butyl ethers and any combination thereof, prothioconazole, in the presence of at least one polyhydric alcohol compound.

In some embodiments, the composition comprising azoxystrobin, polar aprotic solvent, non-ionic emulsifier selected from a group comprising tristyrylphenol ethoxylates, polyalkoxylated butyl ethers and any combination thereof, optionally one or more additional fungicides selected from the group comprising triazoles, in the presence of at least one polyhydric alcohol compound.

In some embodiments, the composition comprising azoxystrobin, benzyl acetate, non-ionic emulsifier selected from a group comprising tristyrylphenol ethoxylates, polyalkoxylated butyl ethers and any combination thereof, optionally one or more additional fungicides selected from the group comprising triazoles, in the presence of at least one polyhydric alcohol compound.

In some embodiments, the composition comprising azoxystrobin, benzyl acetate, non-ionic emulsifier selected from a group comprising tristyrylphenol ethoxylates, polyalkoxylated butyl ethers and any combination thereof, prothioconazole, in the presence of at least one polyhydric alcohol compound.

In some embodiments, the composition comprising azoxystrobin, benzyl acetate, non-ionic emulsifier selected from a group comprising tristyrylphenol ethoxylates, polyalkoxylated butyl ethers and any combination thereof, prothioconazole, in the presence of propylene glycol.

In some embodiments, the composition comprising azoxystrobin, benzyl acetate, non-ionic emulsifier selected from a group comprising tristyrylphenol ethoxylates, prothioconazole, in the presence of propylene glycol.

In some embodiments, the composition comprising azoxystrobin, benzyl acetate, non-ionic emulsifier selected from a group comprising polyalkoxylated butyl ethers, prothioconazole, in the presence of propylene glycol.

In some embodiments, the composition comprising about 1% to about 30% by weight of azoxystrobin based on the total weight of the composition, about 40% to about 70% by weight of benzyl acetate based on the total weight of the composition, about 1% to about 20% by weight of non-ionic emulsifier selected from a group comprising polyoxyethylated aromatics, polyalkoxylated alkyl ethers and any combination thereof based on the total weight of the composition, about 1% to about 30% by weight of prothioconazole based on the total weight of the composition, about 0.5% to about 0.6% by weight of propylene glycol based on the total weight of the composition.

In some embodiments, the composition comprising about 3% to about 20% by weight of azoxystrobin based on the total weight of the composition, about 45% to about 68% by weight of benzyl acetate based on the total weight of the composition, about 8% to about 15% by weight of non-ionic emulsifier selected from a group comprising polyoxyethylated aromatics, polyalkoxylated alkyl ethers and any combination thereof based on the total weight of the composition, about 5% to about 25% by weight of prothioconazole based on the total weight of the composition, about 0.6% to about 5% by weight of propylene glycol based on the total weight of the composition.

In some embodiments, the composition further comprises anionic emulsifier. In some embodiments, the anionic emulsifier is selected from alkylbenzene sulfonate salts. In one embodiment, the anionic emulsifier is selected from dodecylbenzene sulfonate salts. In one embodiment, the anionic emulsifier is selected from calcium docecylbenzene sulfonate.

Non limiting examples of anionic emulsifiers include Nansa EVM 70/2E; Emulsifier 1371A; Geronol FE 4E; Hymal PS 90A; Kemmat HF 60; Nansa EVM 62H; Nansa EVM 70I; Neopelex C 70; Newkalgen AD 85C; Ninate 401; Ninate 401A; Ninate 60E; Ninate 60L; Phenylsulfonate CAL; Pionin A 41C; Rhodacal Rhodacal 60BE-C; Rhodacal 60BHT; Rhodacal 70; Rhodacal 70B; Rhodacal 70B-C; Salca BX; Sinnozon NCX 70; Soprofor S 70; Soprophor 60B; Soprophor 70; Tanemul 1371A; Taycapower BC 2070M; Taycapower BC 2070M-A; Unicabs; Wettol EM 1; Witconate 60L; Witconate P 1220EH; Witconate P 1860.

In some embodiments, the amount of the anionic emulsifier is of about 0.1% to about 10% by weight, based on the total weight of the composition. In some embodiments, the amount of the anionic emulsifier is of about 0.1% to about 6% by weight, based on the total weight of the composition. In one embodiment, the amount of the anionic emulsifier is of about 2.5% by weight, based on the total weight of the composition.

In some embodiments, the composition further comprises non-ionic surfactant(s); in a preferred embodiment the non-ionic surfactant(s) is selected from poly alkoxylated alkyl ethers; in a more preferred embodiment the poly alkoxylated alkyl ether is selected from poly alkoxylated butyl ether.

In some embodiments, the amount of the non-ionic surfactant(s) is of about 0.01% to about 0.3% by weight, based on the total weight of the composition. In an embodiment, the amount of the non-ionic surfactant(s) is of about 0.05% to about 0.2% by weight, based on the total weight of the composition. In another embodiment, the amount of the non-ionic surfactant(s) is of about 0.1% by weight, based on the total weight of the composition.

In some embodiments, the amount of the poly alkoxylated butyl ether surfactant is of about 0.01% to about 0.3% by weight, based on the total weight of the composition. In an embodiment, the amount of the poly alkoxylated butyl ether surfactant is of about 0.05% to about 0.2% by weight, based on the total weight of the composition. In another embodiment, the amount of the poly alkoxylated butyl ether surfactant is of about 0.1% by weight, based on the total weight of the composition.

The present invention also provides a method for controlling and/or preventing pests comprising applying an effective amount of the composition disclosed herein to a locus where the pest is to be controlled and/or prevented so as to thereby control and/or prevent the pest.

In some embodiments, the pest is a phytopathogenic harmful fungi.

The present invention also provides a method for controlling and/or preventing phytopathogenic harmful fungi comprising applying an effective amount of the composition disclosed herein to a locus where the phytopathogenic harmful fungi is to be controlled so as to thereby control the phytopathogenic harmful fungi.

In some embodiments, the locus is a crop field.

In some embodiments, the method of controlling phytopathogenic harmful fungi in a field of crop comprising applying an effective amount of the composition disclosed herein to a field of crop so as to thereby control the phytopathogenic harmful fungi in the field of crop.

In some embodiments, the crop is selected from the group consisting of wheat, barley, rye, triticale, oats, pearl millet, buckwheat, canola and soybean.

Non-limiting examples of pathogens of fungal diseases which may be treated in accordance with the invention include: diseases caused by Net Blotch pathogens, for example Pyrenophora teres; diseases caused by Scald pathogens, for example Rhynchosporium secalis; diseases caused by Spot Blotch pathogens, for example Cochliobolus sativus; diseases caused by Barley Leaf Rust pathogens, for example Puccinia hordei; diseases caused by Powdery Mildew pathogens, for example Blumeria graminis f. sp. hordei; diseases caused by Speckled Leaf Blotch pathogens, for example Septoria tritici; diseases caused by Tan Spot pathogens, for example Pyrenophora tritici-repentis; diseases caused by Leaf Rust pathogens, for example Puccinia recondata, Puccinia triticina; diseases caused by Septoria leaf blotch pathogens, for example Septoria avenae; diseases caused by Crown Rust pathogens, for example Puccinia coronata; diseases caused by Stripe Rust pathogens, for example Puccinia striiformis; diseases caused by Septoria Leaf Spot pathogens, for example Septoria spp.; diseases caused by Rust pathogens, for example Puccinia spp.; diseases caused by Sclerotinia pathogens, for example Sclerotinia sclerotiorum; diseases caused by Virulent Blackleg pathogens, for example Leptosphaeria maculans; diseases caused by Alternaria Black Spot pathogens, for example Alternaria brassicae, Alternaria raphani; diseases caused by Stagonospora Blotch pathogens, for example Stagonospora nodorum; diseases caused by Septoria Leaf and Glume Blotch pathogens, for example Septoria tritici; diseases caused by Ascochyta Blight pathogens, for example Ascochyta rabiei, Ascochyta spp.; diseases caused by White Mold pathogens, for example Sclerotinia sclerotiorum; diseases caused by Anthracnose pathogens, for example Colletotrichum spp.; diseases caused by Asian Soybean Rust pathogens, for example Phakopsora pachyrhizi; diseases caused by Asian Frogeye Leaf Spot pathogens, for example Cercospora sojina; diseases caused by Powdery Mildew pathogens, for example Microsphaera diffusa, Erysiphe pisi, E. polygoni; diseases caused by Cercospora Leaf Spot pathogens, for example Cercospora kikuchii; diseases caused by Ascochyta Blight pathogens, for example Ascochyta spp.; diseases caused by Mycosphaerella Blight pathogens, for example Mycosphaerella pinodes; diseases caused by Anthracnose pathogens, for example Colletotrichum spp.; diseases caused by Sclerotinia pathogens, for example Sclerotinia sclerotiorum; diseases caused by Rusts pathogens, for example Puccinia spp.; diseases caused by Eye spot pathogens, for example Aureobasidium zeae; diseases caused by Rusts pathogens, for example Puccinia sorghi, Puccinia polysora; diseases caused by Eyespot pathogens, for example Kabatiella zeae, Aureobasidium zeae; diseases caused by Northern Blight pathogens, for example Setosphaeria turcica; diseases caused by Southern Corn Leaf Blight pathogens, for example Cochliobolus heterostrophus; diseases caused by Grey Leaf Spot pathogens, for example Cercospora zeae-maydis; diseases caused by Stalk Rot pathogens, for example Fusarium spp., Gibberella spp., Colletotrichum; diseases caused by Rhizoctonia Pod Rot pathogens, for example Rhizoctonia solani; diseases caused by Early Leaf Spot pathogens, for example Cercospora arachidicola; diseases caused by Leaf Rust pathogens, for example Puccinia arachidis; diseases caused by Fusarium Wilt pathogens, for example Fusarium spp.; diseases caused by Gummy Stem Blight pathogens, for example Didymella spp.; diseases caused by Powdery Mildew pathogens, for example Sphaerotheca fuliginea; diseases caused by Leaf Rust pathogens, for example Thekopsora minima; diseases caused by Fruit Rot pathogens, for example Coleophoma empetri, Glomerella cingulata, Phyllosticta vaccinii, Physalospora vaccinii, Allantophomopsis lycopodina, Allantophomopsis cytisporea, Fusicoccum putrefaciens, Penicillium spp., Phomopsis vaccinii, Colletotrichom acutatum, Colletotrichum coccodes; diseases caused by Rhizoctonia Root and Crown Rot pathogens, for example Rhizoctonia solani; diseases caused by Valdensinia Leaf Spot pathogens, for example Valdensinia heterodoxa; diseases caused by Monilinia Blight pathogens, for example Monilinia vaccinii-corymbosi; diseases caused by Valdensinia Leaf Spot pathogens, for example Valdensinia heterodoxa; diseases caused by Monilinia Blight pathogens, for example Monilinia vaccinii-corymbosi; diseases caused by Fruit Rot pathogens, for example Coleophoma empetri, Glomerella cingulata, Phyllosticta vaccinii, Physalospora vaccinii, Allantophomopsis lycopodina, Allantophomopsis cytisporea, Fusicoccum putrefaciens, Penicillium spp., Phomopsis vaccinii, Colletotrichom acutatum, Colletotrichum coccodes; diseases caused by Cottonball Rot pathogens, for example Monilinia oxycocci; diseases caused by Black Root Rot pathogens, for example Rhizoctonia fragariae; diseases caused by Sunflower Rust pathogens, for example Puccinia helianthin, Puccinia carthami; diseases caused by Alternaria Leaf Spot pathogens, for example Alternaria carthami; diseases caused by Sclerotinia Head Rot and Sclerotinia Stem Rot pathogens, for example Sclerotinia sclerotiorum; diseases caused by Cercospora Leaf Spot pathogens, for example Cercospora beticola; diseases caused by Early Blight pathogens, for example Alternaria solani; diseases caused by Late Blight pathogens, for example Phytophthora infestans; diseases caused by Black Dot pathogens, for example Colletotrichum coccodes; diseases caused by Silver Scurf pathogens, for example Helminthosporium solani; diseases caused by Rhizoctonia Stem Canker, Rhizoctonia Stolon Canker pathogens, for example Rhizoctonia spp.; diseases caused by Black Scurf pathogens, for example Rhizoctonia solani; diseases caused by Anthracnose pathogens, for example Colletotrichum coccodes; diseases caused by Eastern Filbert Blight pathogens, for example Anisogramma anomala; diseases caused by Blossom Blight pathogens, for example Aureobasidium spp.; diseases caused by Purple Spot Disease pathogens, for example Stemphylium vesicarium; diseases caused by Downy Mildew Disease pathogens, for example farinosa f.sp. spinaciae; diseases caused by Rhizoctonia Root and Crown Rot, Stem Canker pathogens, for example Rhizoctonia solani; diseases caused by Blue Mold pathogens, for example Peronospora tabacina; diseases caused by Target Spot pathogens, for example Rhizoctonia solani; diseases caused by Blossom Blight pathogens, for example Ascochyta spp., Alternaria spp.; diseases caused by Alternaria Leaf Spot pathogens, for example Alternaria brassicae; diseases caused by Early Blight pathogens, for example Cercospora apii; diseases caused by Late Blight pathogens, for example Septoria apiicola; diseases caused by Anthracnose pathogens, for example Colletotrichum acutatum; diseases caused by Leaf Blight pathogens, for example Alternaria spp., Septoria petroselini; diseases caused by Early Blight pathogens, for example Alternaria solani; diseases caused by Late Blight pathogens, for example Phytophthora infestans; diseases caused by Late Cercospora Leaf Spot pathogens, for example Cercospora beticola; diseases caused by Powdery Mildew pathogens, for example Erysiphe polygoni; diseases caused by Rhizoctonia Stem Canker, Root Rot, Crown Rot pathogens, for example Rhizoctonia solani; diseases caused by Rust pathogens, for example Puccinia spp.; diseases caused by Alternaria Leaf Spot pathogens, for example Alternaria spp.; diseases caused by Anthracnose, for example Glomerella gossypii; diseases caused by Areolate mildew pathogens, for example Ramularia gossypii; diseases caused by Ascochyta Blight pathogens, for example Ascochyta gossypii; diseases caused by Boll rots pathogens, for example Ascochyta gossypii, Alternaria spp., Diplodia spp., Phoma spp; diseases caused by Cotton rust pathogens, for example Puccinia schedonnardi; diseases caused by Diplodia boll rot pathogens, for example Diplodia spp.; diseases caused by Hardlock pathogens, for example Fusarium verticillioides; diseases caused by Leaf spots and blights pathogens, for example Alternaria spp., Ascochyta gossypii, Cercospora spp., Stemphyllium spp.; diseases caused by Southwestern cotton rust pathogens, for example Puccinia cacabata. Puccinia spp.; diseases caused by Stemphyllium leaf spot pathogens, for example Stemphyllium spp.; diseases caused by Target spot pathogens, for example Corynespora cassiicola; diseases caused by Pythium seedling blight pathogens, for example Pythium aphanidermatum; diseases caused by Rhizoctonia seedling blight pathogens, for example Rhizoctonia solani; diseases caused by Fusarium Wilt pathogens, for example Fusarium oxysporum; diseases caused by Southern blight pathogens, for example Sclerotium roflsii; diseases caused by White mold pathogens, for example Sclerotinia sclerotiorum; diseases caused by Rhizoctonia rots pathogens, for example Rhizoctonia spp.; diseases caused by Bean rust pathogens, for example Uromyces appendiculatus; diseases caused by Alternaria blight pathogens, for example Alternaria spp; diseases caused by Alternaria leaf spot pathogens, for example Alternaria alternata; diseases caused by Anthracnose pathogens, for example Anthracnose; diseases caused by Ascochyta leaf and pod spot pathogens, for example Ascochyta spp; diseases caused by Southern blight pathogens, for example Sclerotium rolfsii; diseases caused by Web blight pathogens, for example Rhizoctonia solani; diseases caused by Rhizoctonia root rot pathogens, for example Rhizoctonia solani; diseases caused by Bean rust pathogens, for example Uromyces appendiculatus; diseases caused by Alternaria blight pathogens, for example Alternaria spp.; In some embodiments, the phytopathogenic harmful fungi is selected from Pyrenophora teres, Rhynchosporium secalis, Cochliobolus sativus, Puccinia hordei, Blumeria graminis f. sp. Hordei, Septoria tritici, Pyrenophora tritici-repentis, Puccinia recondata, Puccinia triticina, Septoria avenae, Puccinia coronate, Puccinia striiformis, Septoria spp., Puccinia spp, Sclerotinia sclerotiorum, Leptosphaeria maculans, Alternaria brassicae, Alternaria raphanin, Phakopsora pachyrhizi, Cercospora sojina, Microsphaera diffusa, Erysiphe pisi, E. polygoni, Cercospora kikuchii, Ascochyta spp., Mycosphaerella pinodes, Colletotrichum spp., and Aureobasidium zeae.

In some embodiments, the composition is applied in an amount from about 0.2 L/ha to about 2 L/ha.

In some embodiments, the composition is applied in an amount from about 20 g/ha of at least one additional triazole fungicide to about 400 g/ha of at least one additional triazole fungicide.

In some embodiments, the composition is applied in an amount from about 75 g/ha of at least one additional triazole fungicide to about 150 g/ha of at least one additional triazole fungicide.

In some embodiments, the composition is applied in an amount from about 20 g/ha of prothioconazole to about 400 g/ha of prothioconazole.

In some embodiments, the composition is applied in an amount from about 75 g/ha of prothioconazole to about 150 g/ha of prothioconazole.

In some embodiments, the composition is applied in an amount from 20 g/ha of at least one strobilurin to about 500 g/ha of at least one strobilurin.

In some embodiments, the at least one strobilurin is azoxystrobin.

In some embodiments, the composition is applied in an amount from 20 g/ha of azoxystrobin to about 500 g/ha azoxystrobin.

The present invention also provides the use of the composition disclosed herein for controlling and/or preventing pests.

The present invention also provides the use of the composition disclosed herein for controlling and/or preventing phytopathogenic harmful fungi.

In some embodiments, the phytopathogenic harmful fungi is selected from Pyrenophora teres, Rhynchosporium secalis, Cochliobolus sativus, Puccinia hordei, Blumeria graminis f. sp. Hordei, Septoria tritici, Pyrenophora tritici-repentis, Puccinia recondata, Puccinia triticina, Septoria avenae, Puccinia coronate, Puccinia striiformis, Septoria spp., Puccinia spp, Sclerotinia sclerotiorum, Leptosphaeria maculans, Alternaria brassicae, Alternaria raphanin, Phakopsora pachyrhizi, Cercospora sojina, Microsphaera diffusa, Erysiphe pisi, E. polygoni, Cercospora kikuchii, Ascochyta spp., Mycosphaerella pinodes, Colletotrichum spp., and Aureobasidium zeae.

All the compositions and/or combinations of the invention are liquid compositions. These compositions include the following formulation types: DC (GCPF formulation code for dispersible concentrate); EC (GCPF formulation code for emulsion concentrate); EW (GCPF formulation code for oil-in-water emulsion); ES (GCPF formulation code for emulsion for seed treatment), FS (GCPF formulation code for multiphase concentrate for seed treatment), EO (GCPF formulation code for water-in-oil emulsion; ME (GCPF formulation code for microemulsion; SE (GCPF formulation code for suspoemulsion); SL (GCPF formulation code for water-soluble concentrate); CS (GCPF formulation code for capsule suspension) and AL (GCPF formulation code for ready-to-use liquid formulation, other liquids for undiluted application). Particular preference is given to emulsion concentrates (EC formulation type). An emulsion concentrate is typically understood to mean a composition that forms an oil-in-water emulsion when mixed with water. The emulsion is typically formed spontaneously. The concentrate preferably takes the form of a homogeneous solution. It is typically virtually free of dispersed particles. More particularly, the formulations of the invention provide stable emulsion concentrate formulations of prothioconazole, optionally in combination with further organic, water-insoluble active ingredients, preferably selected from fungicides and insecticides, for treatment of plants.

All the compositions and/or combinations of the invention may comprise further one or more active fungicidal, insecticidal or herbicidal ingredients. Preferably, the compositions of the invention comprise one or more further active insecticidal or fungicidal ingredients, more preferably one or more further active fungicidal ingredients.

Preferred further insecticidal components are, for example, imidacloprid, nitenpyram, acetamiprid, thiacloprid, thiamethoxam, clothianidin, cyantraniliprole, chlorantraniliprole, flubendiamide, tetraniliprole, cyclaniliprole, spirodiclofen, spiromesifen, spirotetramat, abamectin, acrinathrin, chlorfenapyr, emamectin, ethiprole, fipronil, flonicamid, flupyradifurone, indoxacarb, metaflumizone, methoxyfenozid, milbemycin, pyridaben, pyridalyl, silafluofen, spinosad, sulfoxaflor and triflumuron. Preferred further fungicidal components are, for example, bixafen, fenamidone, fenhexamid, fluopicolide, fluopyram, iprovalicarb, isotianil, isopyrazam, pencycuron, penflufen, propineb, ametoctradin, amisulbrom, benthiavalicarb-isopropyl, benzovindiflupyr, boscalid, carbendazim, chlorothanonil, cyazofamid, cyflufenamid, cymoxanil, ethaboxam, famoxadone, fluazinam, flutianil, fluxapyroxad, isopyrazam, mancozeb, mandipropamid, pyriofenone, folpet, oxathiapiprolin, penthiopyrad, probenazole, proquinazid, pydiflumetofen, sedaxane, tebufloquin, valiphenalate, zoxamide, ziram, N-(5-chloro-2-isopropylbenzyl)-N-cyclopropyl-3(difluoromethyl)-5-fluoro-1-methyl-iH-pyrazole-4-carboxamide, N-(5-chloro-2-isopropylbenzyl)-N-5 cyclopropyl-3-(difluoromethyl)-5-fluoro-1-methyl-iH-pyrazole-4-carboxamide, 2-{3-[2-(1-{[3,5bis(difluoromethyl)-1H-pyrazol-1-yl]acetyl}piperidin-4-yl)-1,3-thiazol-4-yl]-4,5-dihydro-1,2-oxazol-5yl}phenyl methanesulfonate, 2-{3-[2-(1-{[3,5-bis(difluoromethyl)-1H-pyrazol-1-yl]acetyl}piperidin-4yl)-1,3-thiazol-4-yl]-4,5-dihydro-1,2-oxazol-5-yl}-3-chlorophenylmethane-sulfonate, (3S,6S,7R,8R)-8-benzyl-3-[({[3-[(isobutyryloxy)methoxy]-4-methoxypyridin-2-yl}carbonyl)amino]-6-methyl-4,9-dioxo-1,5-dioxonan-7-yl 2-methylpropanoate (lyserphenvalpyr).

In addition, all the compositions and/or combinations of the invention may optionally comprise liquid fillers, for example vegetable or mineral oils or esters of vegetable or mineral oils. Suitable vegetable oils are all oils which can typically be used in agrochemicals and can be obtained from plants. Examples include sunflower oil, rapeseed oil, olive oil, castor oil, colza oil, corn oil, cottonseed oil, walnut oil, coconut oil and soya oil. Possible esters are, for example, ethylhexyl palmitate, ethylhexyl oleate, ethylhexyl myristate, ethylhexyl caprylate, isopropyl myristate, isopropyl palmitate, methyl oleate, methyl palmitate, ethyl oleate. Possible mineral oils are Exxsol D100 and white oils.

All the compositions and/or combinations of the invention may comprise further additives such as emulsifiers, penetrants, wetting agents, spreading agents and/or retention agents. Suitable substances are all of those which can typically be used for this purpose in agrochemicals. Suitable additives are, for example, organomodified polysiloxanes, e.g. BreakThru® OE444, BreakThru® S240, Silwett® L77, Silwett® 408; and ethoxy (5) tridecyl mono/di phosphate, e.g. Crodafos™ T5A;

Additional suitable additives which may be present in all the compositions of the invention are antifoams, adjuvants, preservatives, antioxidants, dyes and inert fillers.

Suitable antifoams are all substances which can typically be used for this purpose in agrochemicals. Preference is given to silicone oils, silicone oil formulations, magnesium stearate, phosphinic acids and phosphonic acids. Examples are BreakThru® AF9902 or BreakThru® AF9902 from Evonik Industries AG, Silcolapse® 482 from Bluestar Silicones, Silfoam® SCI 132 from Wacker [dimethylsiloxanes and -silicones, CAS No. 63148-62-9], SAG 1538 or SAG 1572 from Momentive [dimethylsiloxanes and -silicones, CAS-Nr. 63148-62-9] or Fluowet® PL 80.

Possible adjuvants are all substances which can typically be used for this purpose in agrochemicals. Suitable adjuvants are, for example, Synergen SOC, Synergen ACE, Synergen ME, Synergen MAX, Synergen MEGA, Synergen OS, Synergen OS 30 EC, Synergen KN, Hostaphat 1306, Genapol X 060, Genapol X 080, Genapol C 100 or Genapol O 100 from Clamant or InterLock® (Winfield).

Suitable antioxidants are all substances which can typically be used for this purpose in agrochemicals. Preference is given to butylhydroxytoluene [3,5-di-tert-butyl-4-hydroxytoluene, CAS No. 128-37-0] and citric acid.

Possible dyes are all substances which can typically be used for this purpose in agrochemicals. Examples include titanium dioxide, carbon black, zinc oxide, blue pigments, red pigments and Permanent Red FGR. Suitable inert fillers are all substances which can typically be used for this purpose in agrochemicals, and which do not function as thickeners. Preference is given to inorganic particles such as carbonates, silicates and oxides, and also organic substances such as urea-formaldehyde condensates. Examples include kaolin, rutile, silicon dioxide (“finely divided silica”), silica gel and natural and synthetic silicates, and additionally talc.

All the compositions and/or combinations of the invention can be applied in undiluted form or diluted with water. In general, they are diluted with at least one part water, preferably with 10 parts water and more preferably with at least 100 parts water, for example with 1 to 10000, preferably 10 to 5000 and more preferably with 50 to 24,000 parts water, based on one part of the formulation.

The present invention likewise provides an emulsion obtainable by mixing water with the liquid compositions of the invention. The mixing ratio of water to emulsion concentrate may be in the range from 1500:1 to 1:1, preferably 500:1 to 10:1.

The dilution is achieved by pouring the emulsion concentrates of the invention into the water. For rapid mixing of the concentrate with water, it is customary to use agitation, for example stirring. However, agitation is generally unnecessary. Even though the temperature for the dilution operation is an uncritical factor, dilutions are typically conducted at temperatures in the range from 00° C. to 50° C., especially at 10° C. to 30° C. or at ambient temperature.

The water used for dilution is generally tap water. The water may, however, already contain water soluble or finely dispersed compounds which are used in crop protection, for instance nutrients, fertilizers or pesticides. It is possible to add various kinds of oils, wetting agents, adjuvants, fertilizers or micronutrients and further pesticides (e.g. herbicides, insecticides, fungicides, growth regulators, safeners) to the emulsion of the invention in the form of a premix or, if appropriate, not until shortly before use (tank-mix). These may be added to the compositions of the invention in a weight ratio of 1:100 to 100:1, preferably 1:10 to 10:1.

The user will apply the compositions of the invention typically from a pre-dosing system, a backpack sprayer, a spraying tank, a spraying aircraft or an irrigation system; the compositions of the invention is typically diluted to the desired deployment concentration with water, buffer and/or further auxiliaries, which affords the ready-to-use spray liquid or agrochemical composition of the invention. Typically, 2 to 2000 liters, preferably 50 to 400 liters, of the ready-to-use spray liquid are deployed per hectare of useful agricultural area.

The generally diluted compositions of the invention are applied mainly by spraying, especially spraying of the leaves. Application can be conducted by spraying techniques known to those skilled in the art, for example using water as carrier and amounts of spray liquid of about 50 to 1000 liters per hectare, for example from 100 to 200 liters per hectare.

The novel prothioconazole containing compositions have advantageous properties in respect of the treatment of plants; more particularly, they feature good use properties, high stability and high fungicidal activity.

The invention is illustrated by the following examples without limiting it thereby.

### Example 1—Influence of Propylene Glycol (PG)

TABLE 1
Influence of propylene glycol

| | | | | | | | Nansa EVM 70/2E + | | | Emulsifiers + | | | Emulsifiers + | | |
|---|---|---|---|---|---|---|---|---|---|---|---|---|---|---|---|
| | Nansa EVM 70/2E | | | Soprophor CY/8 (TSP) | | | Soprophor CY/8 | | | Azoxystrobin | | | Prothioconazole | | |
| | F1 | F2 | F3 | F4 | F5 | F6 | F7 | F8 | F9 | F10 | F11 | F12 | F13 | F14 | F15 |
| Prothioconazole tech. | X | X | X | X | X | X | X | X | X | X | X | X | 90.63 | 90.63 | 90.63 |
| (99.3%) (g) | | | | | | | | | | | | | | | |
| Azoxystrobin tech. | X | X | X | X | X | X | X | X | X | 121.64 | 121.64 | 121.64 | X | X | X |
| (98.8%) (g) | | | | | | | | | | | | | | | |
| Soprophor | X | X | X | 126.1 | 126.1 | 126.1 | 126.1 | 126.1 | 126.1 | 126.1 | 126.1 | 126.1 | 126.1 | 126.1 | 126.1 |
| CY/8 (g) | | | | | | | | | | | | | | | |
| Nansa EVM | 25.9 | 25.9 | 25.9 | X | X | X | 25.9 | 25.9 | 25.9 | 25.9 | 25.9 | 25.9 | 25.9 | 25.9 | 25.9 |
| 70/2E (g) | | | | | | | | | | | | | | | |
| Propylene | X | 14.1 | 94 | X | 14.1 | 94 | X | 14.1 | 94 | X | 14.1 | 94 | X | 14.1 | 94 |
| glycol (g) | | | | | | | | | | | | | | | |
| benzyl | 737.1 | 723 | 643.1 | 737.1 | 723 | 643.1 | 737.1 | 723 | 643.1 | 737.1 | 723 | 643.1 | 737.1 | 723 | 643.1 |
| acetate (g) | | | | | | | | | | | | | | | |
| Appearance* | C | C | C | H | C | C | H | C | C | H | C | C | H | C | C |

*C = Clear; H = Hazy.

Formulations F1-F15 were kept in the oven at 54° C. to study the accelerated storage stability. Formulations F10-F15 were also kept at 0° C. to check crystal growth.

Storage Stability Oven at 54° C.:

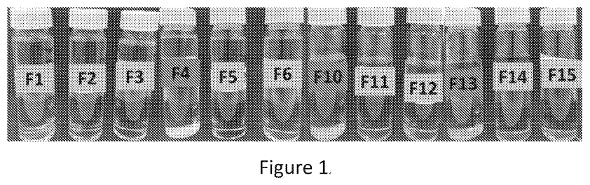

The formulations (see FIG. 1) were kept in the oven at 54° C. for three days, formulations F4, F7, F10 and F13 showed haziness. The rest of the formulations stayed transparent without any sediments also after keeping them two weeks at 54° C.

It is clear that Soprophor® CY/8 causes haziness in these formulations which is solved by the addition of propylene glycol.

Storage Stability at 0° C.:

The formulations were kept at 0° C. for 1 week.

Crystal growth was not observed in the formulations F13, F14, F15 and F10, while formulation F12 resulted in crystal formation. Formulation F11 showed only trace amount of crystals which was negligible. It is demonstrated that the addition of propylene glycol contributes to the stability of the formulation and achieving clear solution after storage stability test at 54° C. for two weeks. However, the addition of propylene glycol in high amounts causes sedimentation.

### Example 2—the Ratio Between Propylene Glycol (PG) and TSP

TABLE 2
Formulations A-I

| Formulation/component | A | B | C | D | E | F | G | H | I |
|---|---|---|---|---|---|---|---|---|---|
| Azoxystrobin tech (g) | 121.46 | 121.46 | 121.46 | 121.46 | 121.46 | 121.46 | 121.46 | 121.46 | 121.46 |
| Soprophor ® | 126.10 | 126.10 | 126.10 | 126.10 | 126.10 | 126.10 | 126.10 | 126.10 | 126.10 |
| CY/8 (TSP) (g) | | | | | | | | | |
| Nansa EVM 70/2E (g) | 25.90 | 25.90 | 25.90 | 25.90 | 25.90 | 25.90 | 25.90 | 25.90 | 25.90 |
| propylene glycol (PG) (g) | 0.00 | 2.21 | 4.41 | 6.35 | 8.79 | 10.43 | 12.32 | 14.20 | 16.41 |
| SURFONIC AG-1705) | 733.0 | 730.8 | 728.6 | 726.6 | 724.2 | 722.6 | 720.7 | 718.8 | 716.6 |
| (Benzyl acetate) (g) | | | | | | | | | |
| Total (g) | 1006.5 | 1006.5 | 1006.5 | 1006.5 | 1006.5 | 1006.5 | 1006.5 | 1006.5 | 1006.5 |
| PG (%) | 0.00 | 0.22 | 0.44 | 0.63 | 0.87 | 1.04 | 1.22 | 1.41 | 1.63 |
| PG/TSP (W/W)% | 0.00 | 1.75 | 3.50 | 5.04 | 6.97 | 8.27 | 9.77 | 11.26 | 13.01 |

Formulations A-I defers in the amount of propylene glycol. The formulations were kept in the oven at 54° C. to study the accelerated storage stability. After less than 5 hours, samples A-C showed haziness, while samples D-I stayed transparent without any sediments even after 2 days at 54° C.

The results emphasize that PG should be at least 5% of the total amount of non-ionic emulsifier, in this case TSP, in the formulation.

### Example 3—Emulsification Test

Formulations 1-11 described below are mostly similar in content (Tables 1-2). They differ from one another in the type of non-ionic emulsifier.

TABLE 3
Formulations 1-11

| Component | % by weight |
|---|---|
| Prothioconazole Tech | 8.24 |
| Azoxystrobin Tech | 11.01 |
| benzyl acetate | 65.5 |
| propylene glycol | 1.3 |
| Nansa EVM 70/2E | 2.35 |
| Ethyan NS 500 LQ | 0.1 |
| Break-Thrue AF 9902 | 0.05 |
| nonionic emulsifier | 11.4 |

TABLE 4
Types of non-ionic emulsifiers

| Formulation No. | Non-ionic emulsifier |
|---|---|
| 1 | Soprophor CY/8 |
| 2 | Soprophor TS/16 |
| 3 | Atlas G-5002L |
| 4 | Emulsogen EL360 |
| 5 | Emulsogen MTP 070 |
| 6 | Synperonic PE/F68 |
| 7 | Synperonic PE/L64 |
| 8 | Berol 829 |
| 9 | Tween 80 |
| 10 | Tween 24 |
| 11 | Agnique RSO 30 |

Formulations 1-11 were prepared in a similar manner by the following procedure:
1. Addition of benzyl acetate, prothioconazole, and azoxystrobin while mixing until the mixture was fully dissolved.
2. Addition of propylene glycol, Nansa EVM 70/2E, Break-Thrue AF 9902 and Ethyan NS 500 LQ.
3. The mixture was stirred until a clear solution was obtained.
4. The premixed was split into different samples by taking 20 mL accompanied by the addition of nonionic emulsifier and stirring.
   200 μg of each sample was added to 40 mL water D, inverted 10 times.

The samples (formulations 1-11) were kept one hour and were observed visually in terms of emulsion stability.

The following table shows the qualitative results in an emulsion test:

| Formulation No. | Non-ionic emulsifier | Emulsion |
|---|---|---|
| 1 | Soprophor CY/8 | ++ |
| 2 | Soprophor TS/16 | ++ |
| 3 | Atlas G-5002L | + |
| 4 | Emulsogen EL360 | − |
| 5 | Emulsogen MTP 070 | − |
| 6 | Synperonic PE/F68 | − |
| 7 | Synperonic PE/L64 | − |
| 8 | Berol 829 | − |
| 9 | Tween 80 | −− |
| 10 | Tween 24 | −− |
| 11 | Agnique RSO 30 | −− |

The emulsion test shows the qualitative results obtained for the quality of the emulsion (phase separation). The worst emulsion scored −−, a bad emulsion scored −, a good emulsion scored + and the best ones scored ++. Both the phase separation and the time of its occurrence were observed when evaluating the emulsion. A double plus sign (++) means that no separation was noted at the end of 1 h, and complete re-emulsification was observed at the end of 24 h. A single (+) sign means that some oil did separate out after 1 hour.

1. A composition comprising at least one strobilurin fungicide, polar aprotic solvent, non-ionic emulsifier selected from a group comprising polyoxyethylated aromatics, polyalkoxylated alkyl ethers and any combination thereof, optionally one or more additional fungicides selected from the group comprising triazoles in the presence of at least one polyhydric alcohol compound.

2. The composition according to claim 1, wherein the polar aprotic solvent is selected from a group comprising acetophenone, benzyl acetate, 2-heptanone, DMSO, Triisobutyl phosphate and any combination thereof.

3. The composition according to claim 1, wherein the polar aprotic solvent is selected from a group consisting of benzyl acetate, acetophenone and any combination thereof.

4. The composition according to claim 1, wherein the polar aprotic solvent is benzyl acetate.

5. The composition according to claim 1, wherein the polyoxyethylated aromatic is selected from the family of tristyrylphenol ethoxylates.

6. The composition according to claim 1, wherein the amount of the non-ionic emulsifier selected from a group comprising polyoxyethylated aromatics, polyalkoxylated alkyl ethers and any combination thereof is of about 1% to about 20% by weight, based on the total weight of the composition.

7. The composition according to claim 6, wherein the amount of the non-ionic emulsifier selected from a group comprising polyoxyethylated aromatics, polyalkoxylated alkyl ethers and any combination thereof is of about 8% to about 15% by weight, based on the total weight of the composition.

8. The composition according to claim 1, wherein the at least one polyhydric alcohol compound is at the amount of about 5% to about 50% by weight based on the total amount of the non-ionic emulsifier selected from a group comprising polyoxyethylated aromatics, polyalkoxylated alkyl ethers and any combination thereof.

9. The composition according to claim 1, wherein the at least one strobilurin fungicide is selected from a group consisting of fluoxastrobin, mandestrobin, pyribencarb, azoxystrobin, bifujunzhi, coumoxystrobin, enoxastrobin, flufenoxystrobin, jiaxiangjunzhi, picoxystrobin, pyraoxystrobin, pyraclostrobin, pyrametostrobin, triclopyricarb, dimoxystrobin, fenaminstrobin, metominostrobin, orysastrobin, kresoxim-methyl, trifloxystrobin and any combination thereof.

10. The composition according to claim 9, wherein the strobilurin fungicide is azoxystrobin.

11. The composition according to claim 1, wherein the amount of the at least one strobilurin fungicide is of about 1% to about 30% by weight, based on the total weight of the composition.

12. The composition according to claim 1, wherein the amount of the polar aprotic solvent is of about 40% to about 70% by weight, based on the total weight of the composition.

13. The composition according to claim 1, wherein the amount of benzyl acetate is of about 40% to about 70% by weight, based on the total weight of the composition.

14. The composition according to claim 1, wherein the one or more additional fungicides selected from the group comprising triazoles is selected from a group consisting of azaconazole, bromuconazole, cyproconazole, diclobutrazol, difenoconazole, diniconazole, diniconazole-M, epoxiconazole, etaconazole, fenbuconazole, fluoxytioconazole, fluquinconazole, flusilazole, flutriafol, furconazole, furconazole-cis, hexaconazole, imibenconazole, ipconazole, ipfentrifluconazole, mefentrifluconazole, metconazole, myclobutanil, penconazole, propiconazole, prothioconazole, quinconazole, simeconazole, tebuconazole, tetraconazole, triadimefon, triadimenol, triticonazole, uniconazole, uniconazole-P and any combination thereof.

15. The composition according to claim 14, wherein the one or more additional fungicides selected from the group comprising triazoles is prothioconazole.

16. The composition according to claim 1, wherein the amount of the one or more additional fungicides selected from the group comprising triazoles is of about 1% to about 30% by weight, based on the total weight of the composition.

17. The composition according to claim 16, wherein the amount of prothioconazole is of about 1% to about 30% by weight, based on the total weight of the composition.

18. The composition according claim 1, wherein the ratio between the polar aprotic solvent and the at least one polyhydric alcohol compound is of about 8:1 to about 350:1.

19. A method for controlling and/or preventing pests comprising applying an effective amount of the composition according to claim 1 to a locus where the pest is to be controlled and/or prevented so as to thereby control and/or prevent the pest.

20. The method of claim 19, wherein the pest is a phytopathogenic harmful fungi.

21. A method for controlling and/or preventing phytopathogenic harmful fungi comprising applying an effective amount of the composition according to claim 1 to a locus where the phytopathogenic harmful fungi is to be controlled so as to thereby control the phytopathogenic harmful fungi.

22. The method according to claim 19, wherein the locus is a crop field.

23. A method of controlling phytopathogenic harmful fungi in a field of crop comprising applying an effective amount of the composition according to claim 1 to a field of crop so as to thereby control the phytopathogenic harmful fungi in the field of crop.

24. The method according to claim 22, wherein the crop is selected from the group consisting of wheat, barley, rye, triticale, oats, pearl millet, buckwheat, canola and soybean.

25. The method according to claim 20, wherein the phytopathogenic harmful fungi is selected from Pyrenophora teres, Rhynchosporium secalis, Cochliobolus sativus, Puccinia hordei, Blumeria graminis f. sp. Hordei, Septoria tritici, Pyrenophora tritici-repentis, Puccinia recondata, Puccinia triticina, Septoria avenae, Puccinia coronate, Puccinia striiformis, Septoria spp., Puccinia spp, Sclerotinia sclerotiorum, Leptosphaeria maculans, Alternaria brassicae, Alternaria raphanin, Phakopsora pachyrhizi, Cercospora sojina, Microsphaera diffusa, Erysiphe pisi, E. polygoni, Cercospora kikuchii, Ascochyta spp., Mycosphaerella pinodes, Colletotrichum spp., and Aureobasidium zeae.

26. The method according to claim 19, wherein the composition is applied in an amount from about 0.2 L/ha to about 2 L/ha.

27. The method according to claim 19, wherein the composition is applied in an amount from about 20 g/ha of triazole fungicide to about 400 g/ha of triazole fungicide.

28. The method according to claim 27, wherein the composition is applied in an amount from about 75 g/ha of triazole fungicide to about 150 g/ha of triazole fungicide.

29. The method according to claim 19, wherein the composition is applied in an amount from 20 g/ha of strobilurin to about 500 g/ha of strobilurin.

30. The method according to claim 29, wherein the strobilurin is azoxystrobin.

31-33. (canceled)

34. A composition comprising about 11% by weight of azoxystrobin based on the total weight of the composition, about 66% by weight of benzyl acetate based on the total weight of the composition, about 11% by weight of non-ionic emulsifier selected from a group comprising polyoxyethylated aromatics, polyalkoxylated alkyl ethers and any combination thereof based on the total weight of the composition, about 8% by weight of prothioconazole based on the total weight of the composition, about 1.3% by weight of propylene glycol based on the total weight of the composition.

35. A composition comprising about 1% to about 30% by weight of azoxystrobin based on the total weight of the composition, about 40% to about 70% by weight of benzyl acetate based on the total weight of the composition, about 1% to about 20% by weight of non-ionic emulsifier selected from a group comprising polyoxyethylated aromatics, polyalkoxylated alkyl ethers and any combination thereof based on the total weight of the composition, about 1% to about 30% by weight of prothioconazole based on the total weight of the composition, about 0.5% to about 0.6% by weight of propylene glycol based on the total weight of the composition.

36. A composition comprising about 3% to about 20% by weight of azoxystrobin based on the total weight of the composition, about 45% to about 68% by weight of benzyl acetate based on the total weight of the composition, about 8% to about 15% by weight of non-ionic emulsifier selected from a group comprising polyoxyethylated aromatics, polyalkoxylated alkyl ethers and any combination thereof based on the total weight of the composition, about 5% to about 25% by weight of prothioconazole based on the total weight of the composition, about 0.6% to about 5% by weight of propylene glycol based on the total weight of the composition.
